(19) United States
(12) Patent Application Publication
(10) Pub. No.: US 2026/0079763 A1
(43) Pub. Date: Mar. 19, 2026

(54) MODEL PLATFORM-BASED SCHEDULING METHOD, MEDIUM, AND DEVICE

(71) Applicant: Beijing Volcano Engine Technology Co., Ltd., Beijing (CN)

(72) Inventors: Binbin CHEN, Beijing (CN); Tieying ZHANG, Los Angeles, CA (US); Jianjun CHEN, Los Angeles, CA (US); Rui SHI, Beijing (CN)

(21) Appl. No.: 19/223,978

(22) Filed: May 30, 2025

(30) Foreign Application Priority Data
Sep. 14, 2024 (CN) 202411296740.4

(51) Int. Cl. G06F 9/50

(52) U.S. Cl. CPC G06F 9/505; G06F 9/5038; G06F 2209/5019

(57) ABSTRACT

The present disclosure relates to a model platform-based scheduling method, medium and device. The method includes: receiving a model rescheduling request for a model platform; determining, from the computing cluster, a plurality of target computing nodes participating in rescheduling according to the model rescheduling request; determining a target scheduling strategy that satisfies a collaborative scheduling objective of the collaborative scheduling in the model orchestration dimension and the load balancing dimension, according to node information of the plurality of target computing nodes, model information corresponding to models carried by the plurality of target computing nodes and inference traffic information carried by the plurality of target computing nodes, combined with an optimization model; and rescheduling the models carried by the target computing nodes according to the target model orchestration mode, and controlling allocation of inference traffic to the target computing nodes according to the target inference traffic allocation mode.

### CROSS-REFERENCE TO RELATED APPLICATION

This application claims the priority to and benefits of the Chinese Patent Application, 202411296740.4, which was filed on Sep. 14, 2024. All the aforementioned patent applications are hereby incorporated by reference in their entireties.

### TECHNICAL FIELD

The present disclosure relates to the field of computer technology, and more specifically, relates to a model platform-based scheduling method, apparatus, medium, device and program product.

### BACKGROUND

With development of the Artificial Intelligence (AI) technology, providing an inference service for a user based on a model platform has become a mainstream approach in AI applications. As operation of the model platform relies on efficient, stable and elastic computing power, requirements on the infrastructure for the model platform is growing.

In practical applications, in order to ensure the efficient and low-latency service performance of the model platform, more computing power is usually used to deploy more models. However, it will greatly increase the service cost of the model platform, and due to instability of inference demands, deploying more computing power will also cause a lot of computing resources to be wasted. In order to control the cost, fewer computing resources may be used to deploy the model. However, this leads to the model platform being prone to paralysis or having severe service delays during a surge of the inference demands, thus greatly affecting the service performance of the model platform.

Therefore, there is an urgent need for a resource scheduling solution tailored to the model platform, which can improve the resource utilization while meeting the service performance so as to effectively reduce the service cost.

### SUMMARY

This section of Summary is provided to introduce concepts in a simplified form that will be further described in detail in the section of Detailed Description below. This section of Summary is not intended to identify key features or essential features of the claimed technical solutions, nor is it intended to limit the scope of the claimed technical solutions.

At least one embodiment of the present disclosure provides a model platform-based scheduling method, and the method includes:
receiving a model rescheduling request for a model platform, where the model platform provides an inference service through models deployed on a computing cluster, and the model rescheduling request is used to request collaborative scheduling of the models on the computing cluster in a model orchestration dimension and a load balancing dimension;
determining, from the computing cluster, a plurality of target computing nodes participating in rescheduling according to the model rescheduling request;
determining a target scheduling strategy that satisfies a collaborative scheduling objective of the collaborative scheduling in the model orchestration dimension and the load balancing dimension, combined with an optimization model, according to node information of the plurality of target computing nodes, model information corresponding to models carried by the plurality of target computing nodes and inference traffic information carried by the plurality of target computing nodes, where the target scheduling strategy comprises a target model orchestration mode and a target inference traffic allocation mode; and
rescheduling the models carried by the target computing nodes according to the target model orchestration mode, and controlling allocation of inference traffic to the target computing nodes according to the target inference traffic allocation mode.

At least one embodiment of the present disclosure provides a model platform-based scheduling apparatus, and the apparatus includes:
a receiving module, configured to receive a model rescheduling request for a model platform, where the model platform provides an inference service through models deployed on a computing cluster, and the model rescheduling request is used to request collaborative scheduling of the models on the computing cluster in a model orchestration dimension and a load balancing dimension;
a first determination module, configured to determine, from the computing cluster, a plurality of target computing nodes participating in rescheduling according to the model rescheduling request;
a second determination module, configured to determine a target scheduling strategy that satisfies a collaborative scheduling objective of the collaborative scheduling in the model orchestration dimension and the load balancing dimension, combined with an optimization model, according to node information of the plurality of target computing nodes, model information corresponding to models carried by the plurality of target computing nodes and inference traffic information carried by the plurality of target computing nodes, where the target scheduling strategy comprises a target model orchestration mode and a target inference traffic allocation mode; and
a scheduling module, configured to reschedule the models carried by the target computing nodes according to the target model orchestration mode, and control allocation of inference traffic to the target computing nodes according to the target inference traffic allocation mode.

At least one embodiment of the present disclosure provides a computer-readable medium having a computer program stored thereon, when the computer program is executed by a processing apparatus, implementing the model platform-based scheduling method according to any of the embodiment provided by the present disclosure.

At least one embodiment of the present disclosure provides an electronic device, and the device includes: at least one storage apparatus, having a computer program stored thereon; and at least one processing apparatus, being configured to execute the computer program in the at least one storage apparatus to implement the model platform-based scheduling method according to any of the embodiment provided by the present disclosure.

At least one embodiment of the present disclosure provides a computer program product including the computer program, and when the computer program is executed by a processor, implementing the model platform-based scheduling method according to any of the embodiment provided by the present disclosure.

The additional features and advantageous effects of the present disclosure will be elaborated in detail in the subsequent section of Detailed Description.

### BRIEF DESCRIPTION OF DRAWINGS

Referring to the drawings and the following detailed description, the above and other features, advantages, and aspects of the various embodiments of the present disclosure will become more apparent. Throughout the drawings, the same or similar reference numerals denote the same or similar elements. It should be understood that the drawings are schematic, and the components and elements are not necessarily drawn to scale. In the drawings:

FIG. 1 is a schematic diagram of a large language model platform according to at least one embodiment of the present disclosure.

FIG. 2 is a flowchart of a model platform-based scheduling method according to at least one embodiment of the present disclosure.

FIG. 3 is a structural schematic diagram of a model platform-based scheduling apparatus according to at least one embodiment of the present disclosure.

FIG. 4 is a structural schematic diagram of an electronic device according to at least one embodiment of the present disclosure.

### DETAILED DESCRIPTION

The embodiments of the present disclosure will be described in greater detail below with reference to the drawings. Although certain embodiments of the present disclosure are shown in the drawings, it should be understood, however, that the present disclosure may be realized in various forms and should not be construed as being limited to the embodiments set forth herein, but rather are provided for a more thorough and complete understanding of the present disclosure. It should be understood that the drawings and embodiments of the present disclosure are for exemplary purposes only and are not intended to limit the scope of protection of the present disclosure.

It should be understood that the individual steps documented in the method embodiments of the present disclosure may be performed in a different order, and/or in parallel. Furthermore, the method embodiments may include additional steps and/or omit performing the illustrated steps. The scope of the present disclosure is not limited in this regard.

The term “including” and variations thereof, as used herein, is open-ended, i.e., “including but not limited to.” The term “based on” is “based at least in part on.” The term “one embodiment” means “at least one embodiment”: the term “another embodiment” means “at least one additional embodiment”: the term “another embodiment” means “at least one other embodiment”; and the term “some embodiments” means “at least some embodiments”. Related definitions of other terms will be given in the following description.

It should be noted that the concepts of “first”, “second” and the like mentioned in the present disclosure are only used to differentiate different apparatuses, modules or units, and are not used to define the order or interdependence of the functions performed by these apparatuses, modules or units.

It should be noted that the modifications of “one” and “more than one” mentioned in the present disclosure are schematic rather than limiting, and the person skilled in the art should understand that, unless otherwise expressly stated in the context, they should be understood as “one or more”.

The names of the messages or information interacting between a plurality of apparatuses of the disclosure are used for illustrative purposes only and are not intended to limit the scope of those messages or information.

The model platform-based scheduling method provided in the present disclosure can be applied to any type of model platform that relies on a computing cluster for deployment. For example, the model platform may be a large language model platform, an image model platform, a speech model platform, a video model platform, a code model platform, etc. These different types of model platforms can provide corresponding inference services to users. The present disclosure imposes no restriction on the function of the model platforms. Hereinbelow, the model platform-based scheduling method proposed by the present disclosure will be explained by using only a large language model platform as an example.

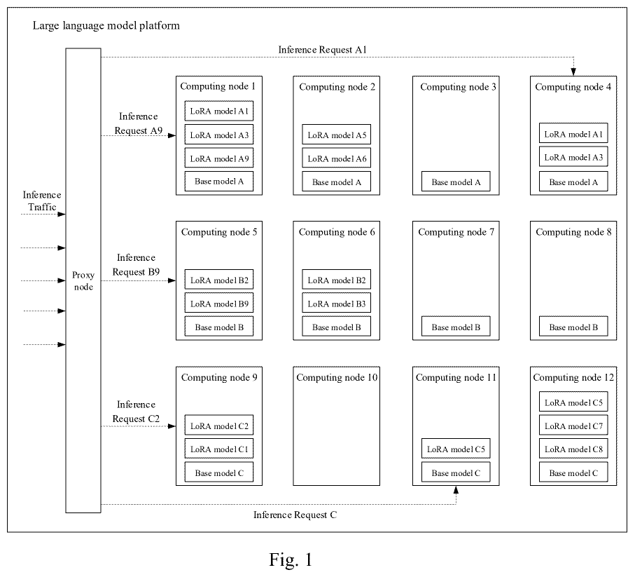

FIG. 1 is a schematic diagram of a large language model platform according to at least one embodiment of the present disclosure. As shown in FIG. 1, the large language model platform is deployed in a computing cluster. The computing cluster has a plurality of computing nodes deployed therein, each of which may be equipped with a corresponding Graphics Processing Unit (GPU) to support calculations for the large language model. Within each computing node, one base model and several Low-Rank Adaptation Models (LoRA models) may be deployed. As shown in FIG. 1, the computing node 1 includes a base model A, a LoRA model A1, a LoRA model A3 and a LoRA model A9.

The base model refers to a pre-trained large language model, and may serve as a starting point for other tasks. The LoRA models are obtained by fine-tuning the base model through a low-rank adaptation method.

A proxy node receives inference traffic transmitted by a user, which is used to request a service of the large language model. According to the large language model requested by the inference traffic, the proxy node forwards the inference traffic to the computing node where the large language mode is deployed. The computing node outputs an inference result corresponding to the inference traffic, and returns the inference result to the user through the proxy node. For example, as shown in FIG. 1, the proxy node transmits an inference request A9 in the inference traffic to the computing node 1.

The model platform-based scheduling method provided in the embodiments of the present disclosure can be used for rescheduling the base model and the LoRA models in the large language model platform as shown in FIG. 1. Of course, the model platform-based scheduling method provided in the embodiments of the present disclosure can also be used for scheduling other models deployed on a plurality of computing nodes in a clustered manner.

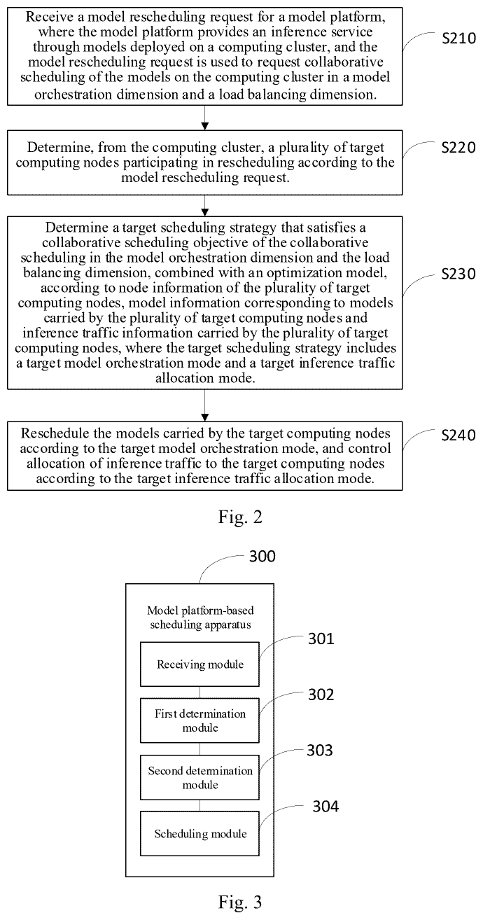

FIG. 2 is a flowchart of a model platform-based scheduling method according to at least one embodiment of the present disclosure. As shown in FIG. 2, the embodiments of the present disclosure provide a model platform-based scheduling method, which can be executed by an electronic device, and specifically, by a model platform-based scheduling apparatus. The apparatus can be realized through software and/or hardware, and is configured within the electronic device. As shown in FIG. 2, the method may include the following steps.

S210: Receive a model rescheduling request for a model platform, where the model platform provides an inference service through models deployed on a computing cluster, and the model rescheduling request is used to request collaborative scheduling of the models on the computing cluster in a model orchestration dimension and a load balancing dimension.

Here, the model platform may be the large language model platform as shown in FIG. 1. Of course, the model platform may also be a model platform for deploying other types of models (e.g., image recognition models, etc.) in a clustered manner. The large language model platform provides the inference service to the user through a large language model deployed on the computing cluster.

For example, the model rescheduling request may be triggered periodically. Of course, the model rescheduling request may also be triggered by a specific event. For example, when the deployment density of the models in the model platform is smaller than a preset density threshold, the model rescheduling request is triggered.

Scheduling in the model orchestration dimension refers to rescheduling the deployment of the models in the model platform to optimize the deployment of the a plurality of models on the computing cluster. Scheduling in the load balancing dimension refers to scheduling the allocation of inference traffic to each computing node in the computing cluster so that the inference traffic is evenly distributed to the computing nodes of the computing cluster.

In the embodiments of the present disclosure, the model rescheduling request indicates collaborative scheduling of the models on the computing cluster in the model orchestration dimension and the load balancing dimension. In other words, in the model rescheduling process, both the deployment of the models on the computing cluster and the allocation of the inference traffic to the computing nodes are considered.

S220: Determine, from the computing cluster, a plurality of target computing nodes participating in rescheduling according to the model rescheduling request.

Here, when the model rescheduling request is received, the plurality of target computing nodes participating in rescheduling may be determined according to the plurality of computing nodes indicated in the model rescheduling request. The plurality of computing nodes indicated in the model rescheduling request may be a plurality of computing nodes required to participate in rescheduling that are selected by the user. Of course, in other implementations, when the model rescheduling request is received, the electronic device may select, from the computing cluster, the plurality of target computing nodes required to participate in rescheduling. For example, as shown in FIG. 1, in response to the model rescheduling request, some or all of the computing nodes in the large language model platform may be determined as the target computing nodes required to participate in rescheduling.

S230: Determine a target scheduling strategy that satisfies a collaborative scheduling objective of the collaborative scheduling in the model orchestration dimension and the load balancing dimension, combined with an optimization model, according to node information of the plurality of target computing nodes, model information corresponding to models carried by the plurality of target computing nodes and inference traffic information carried by the plurality of target computing nodes, where the target scheduling strategy includes a target model orchestration mode and a target inference traffic allocation mode.

Here, the node information of the plurality of target computing nodes may include: a set of all the computing nodes in the computing cluster, the maximum traffic that can be carried by each computing node, a computing node requiring preservation of the original model orchestration, and a computing node with a model that has the minimum guaranteed traffic requirement.

When the plurality of target computing nodes for rescheduling are determined, the plurality of models deployed on the plurality of target computing nodes may be determined. For example, as shown in FIG. 1, when the plurality of target computing nodes indicated by the model rescheduling request are a computing node 1, a computing node 2 and a computing node 3, then the plurality of models participating in rescheduling are a base model A, a LoRA model A1, a LoRA model A3, a LoRA model A9, a base model A, a LoRA model A5, a LoRA model A6 and a base model A.

The model information of the models may refer to the information of the models themselves. The model information of the models may include an original deployment of the models (including the base models and the LoRA models) on the plurality of target computing nodes, the dependency between the LoRA models and the base models, information for describing the computing nodes on which each model can be deployed, a slot (resource unit) value of the base models on the computing nodes, a rank (the rank of low-rank matrices in the LoRA models) value of the LoRA models, and the minimum number of copies of the models.

The inference traffic information carried by the plurality of target computing nodes may refer to the total inference traffic received by the models carried on the target computing nodes, the minimum guaranteed inference traffic information that needs to be allocated to the models carried on the target computing nodes, and the minimum guaranteed traffic requirement of the models carried on the target computing nodes.

It is worth noting that the node information, the model information and the inference traffic information may be directly obtained from the large language model platform.

In the embodiments of the present disclosure, the optimization model is used to represent the conversion relationship between the original model orchestration mode of the models on the computing nodes and the new target model orchestration mode of the models on the computing nodes.

For example, the optimization model may be as follows:

$$\{ \begin{matrix}{inc}_{i , j} = 0 \\ {dec}_{i , j} = 1 - {x}_{i , j}\end{matrix} , ∀ ( i , j ) ∈ \{ {𝕊}_{model} \times {𝕊}_{pod} \vert {\hat{x}}_{i , j} = 1 \} \qquad ( 1 )$$

$$\{ \begin{matrix}{inc}_{i , j} = {x}_{i , j} \\ {dec}_{i , j} = 0\end{matrix} , ∀ ( i , j ) ∈ \{ {𝕊}_{model} \times {𝕊}_{pod} \vert {\hat{x}}_{i , j} = 0 \} \qquad ( 2 )$$

Where \hat{x}_{i,j}=1 represents that a model i is deployed on a computing node j in the original model orchestration; \hat{x}_{i,j}=0 represents that the model i is not deployed on the computing node j in the original model orchestration; [symbol] _{pod} represents a set including all of the computing nodes; [symbol] _{model} represents a set of all the base models and the LoRA models; (i,j) represents the model i on the computing node j; x_{i,j} represents whether the model i is deployed on the computing node j in the target model orchestration mode; when x_{i,j}=1, it represents that the model i is deployed on the computing node j; when x_{i,j}=0, it represents that the model i is not deployed on the computing node j; inc_{i,j} represents whether a model creation action for the model i occurs on the computing node j during conversion from the original model orchestration mode to the target model orchestration mode; when inc_{i,j}=1, it represents that the model creation action for the model i occurs on the computing node j; when inc_{i,j}=0, it represents that the model creation action for the model i does not occur on the computing node j; dec_{i,j} represents whether a model deletion action for the model i occurs on the computing node j during conversion from the original model orchestration mode to the target model orchestration mode; when dec_{i,j}=1, it represents that the model deletion action for the model i occurs on the computing node j; and when dec_{i,j}=0, it represents that the model deletion action for the model i does not occur on the computing node j.

$${\sum }_{ib ∈ {𝕊}_{base}} {x}_{ib , j} \leq M \cdot {z}_{j} , ∀ j ∈ {𝕊}_{pod} \qquad ( 3 )$$

Where ib∈ [symbol] _{base} represents a set of all the base models; x_{ib,j} represents whether a base model ib is deployed on the computing node j; j∈ [symbol] _{pod} represents a set of all the computing nodes; zⱼ represents whether a model is deployed on the computing node j; when zⱼ=1, it represents that a model is deployed on the computing node j; when zⱼ=0, it represents that no model is deployed on the computing node j; and M is an infinitely large value.

It is noted that the optimization model is composed of equations (1), (2) and (3). Equation (1) and equation (2) reflect the changes in deployment of the models from the original model orchestration mode to the target model orchestration mode after scheduling. Equation (3) describes the changes in the computing nodes for deploying the models from the original model orchestration mode to the target model orchestration mode after scheduling.

In the embodiments of the present disclosure, the collaborative scheduling objective is used to collaboratively schedule the models on the computing cluster in the model orchestration dimension and the load balancing dimension so as to collaboratively adjust the model deployment of the models and the traffic allocation for allocating the inference traffic to the computing nodes. In other words, the collaborative scheduling objective can simultaneously consider both the model deployment of the plurality of models on the plurality of target computing nodes and the inference traffic allocation for allocating the inference traffic to the computing nodes so as to synchronously optimize the utilization of the GPU and the optimal scheduling of inference latency.

The target scheduling strategy that satisfies the collaborative scheduling objective of collaborative scheduling in the model orchestration dimension and the load balancing dimension may be determined by using a corresponding scheduling algorithm through the model information, the node information, the inference traffic information and the optimization model. The target scheduling strategy includes a target model orchestration mode and a target inference traffic allocation mode. The target model orchestration mode refers to the deployment of models on the plurality of target computing nodes, and the target inference traffic allocation mode may refer to the ratio of the inference traffic allocated to each computing node in the cluster. For example, the target inference traffic allocation mode may refer to the ratio of the inference traffic allocated on the computing nodes hosting each copy of the large language model.

It should be understood that in the embodiments of the present disclosure, the optimization model may be a Mixed-Integer Linear Programming (MILP) model.

For example, the scheduling algorithm may be a mathematical programming solver such as HIGHS, CPLEX, or Gurobi. The target model orchestration mode is determined by computing a value of x_{i,j}, and the target inference traffic allocation mode is determined by computing a value of y_{i,j}.

In the embodiments of the present disclosure, the collaborative scheduling objective is used to reschedule the models on the plurality of target computing nodes in the model orchestration dimension and the load balancing dimension so as to synchronously optimize the model orchestration and the traffic allocation, thereby achieving collaborative rescheduling of the models in the model orchestration dimension and the load balancing dimension.

S240: Reschedule the models carried by the target computing nodes according to the target model orchestration mode, and control allocation of inference traffic to the target computing nodes according to the target inference traffic allocation mode.

Here, after the target model orchestration mode and the target inference traffic allocation mode are obtained, the models are deployed on the computing nodes corresponding to the target model orchestration mode according to the corresponding target model orchestration mode, and the ratio of the inference traffic allocated from the proxy node to the plurality of computing nodes is controlled according to the target inference traffic allocation mode.

For example, when the optimal solution for y_{i,j} is \tilde{y}_{i,j}, then the proxy node may forward the inference traffic of the model i to the corresponding computing node j with a probability of

$$\frac{{\tilde{y}}_{i , j}}{{\sum }_{j} {\tilde{y}}_{i , j}} .$$

It should be noted that the target inference traffic allocation mode may be distributed to the proxy node in the form of a configuration file so that the proxy node allocates the inference traffic to each computing node in the model inference system according to the target inference traffic allocation mode included in the configuration file.

Based on the above technical solutions, by receiving a model rescheduling request for a model platform, according to the model rescheduling request, determining, from a computing cluster, a plurality of target computing nodes participating in rescheduling; determining a target scheduling strategy that satisfies a collaborative scheduling objective of collaborative scheduling in the model orchestration dimension and the load balancing dimension, combined with an optimization model, according to node information of the plurality of target computing nodes, model information corresponding to models carried by the plurality of target computing nodes and inference traffic information carried by the plurality of target computing nodes; and then performing model orchestration scheduling and traffic scheduling according to the target scheduling strategy. This enables the collaborative scheduling of the models in the model orchestration dimension and the load balancing dimension during rescheduling of the models, thereby achieving collaborative complementarity between model deployment scheduling and traffic scheduling, and simultaneously improving the resource utilization of the model platform and reducing the inference latency in the model inference system.

It should be noted that model rescheduling may be performed through a rescheduler in the embodiments of the present disclosure. When the rescheduler receives the model rescheduling request, the rescheduler determines the plurality of target computing nodes participating in rescheduling from the model platform in response to the model rescheduling request, and then executes the above steps S210 to S240 to reschedule the models on the plurality of target computing nodes.

It should be understood that the model information, the node information and the inference traffic information obtained by the rescheduler may be used as input constants of the optimization model. Through the scheduling algorithm, the target model orchestration mode and the target inference traffic allocation mode that satisfy the collaborative scheduling objective are obtained by calculation.

In some achievable implementations, in S230, the node information, the model information, and the inference traffic information may be input into the optimization model, and the target scheduling strategy that satisfies the collaborative scheduling objective is determined within a first constraint corresponding to the optimization model.

Here, the first constraint is used to constrain a model deployment rule for the models on the computing nodes and a traffic allocation rule for allocating the inference traffic to the computing nodes.

The model deployment rule is used to define the rule that the deployment of the models on the computing nodes should follow during model rescheduling. The traffic allocation rule is used to define the rule that should be followed when the proxy node allocates the inference traffic to the computing nodes during traffic scheduling.

For example, the first constraint may comprise:

$${y}_{i , j} \leq M \cdot {x}_{i , j} , ∀ i ∈ {𝕊}_{model} , j ∈ {𝕊}_{pod} \qquad ( 4 )$$

Where y_{i,j} represents the inference traffic carried by the model i on the computing node j; M is an infinitely large value; x_{i,j}, represents whether the model i is deployed on the computing node j in the target model orchestration mode; i∈ [symbol] _{model} represents a set of all the base models and the LoRA models; and j∈ [symbol] _{pod} represents a set of all the computing nodes.

It should be noted that equation (4) is actually used to represent that the model not deployed on the computing node j is not allowed to be allocated with the inference traffic, so as to constrain the traffic allocation rule for allocating the inference traffic to the computing nodes.

$${request}_{i} = {\sum }_{j ∈ {𝕊}_{pod}} {y}_{i , j} , ∀ i ∈ {𝕊}_{model} \qquad ( 5 )$$

Where request; represents the total inference traffic received by the model i; j∈ [symbol] _{pod} represents a set of all the computing nodes; y_{i,j} represents the inference traffic carried by the model i on the computing node j; and i∈ [symbol] _{model} represents a set of all the base models and the LoRA models.

It should be noted that equation (5) is actually used to represent that all the inference traffic corresponding to each model should be allocated to the computing nodes used for model deployment without omission, so as to constrain the traffic allocation rule for allocating the inference traffic to the computing nodes.

$${\sum }_{ib ∈ {𝕊}_{base}} {x}_{ib , j} \leq 1 , ∀ j ∈ {𝕊}_{pod} \qquad ( 6 )$$

Where ib∈ [symbol] _{base} represents a set of all the base models; x_{ib,j} represents whether a base model ib is deployed on the computing node j; and j∈ [symbol] _{pod} represents a set of all the computing nodes.

It should be noted that equation (6) is used to represent that only one base model can be deployed on each computing node, so as to constrain the model deployment rule of the models on the computing nodes.

$${\sum }_{il ∈ {𝕊}_{LoRA}^{ib}} {rank}_{il} \cdot {x}_{il , j} \leq {slot}_{ib , j} \cdot {x}_{ib , j} , ∀ ib ∈ {𝕊}_{base} , j ∈ {𝕊}_{pod} Where il ∈ {𝕊}_{LoRA}^{ib} \qquad ( 7 )$$

represents a set of LoRA models that depend on the base model ib; rankᵢₗ represents the rank value of the LoRA model il; x_{il,j} represents the LoRA model il deployed on the computing node j; slot_{ib,j} represents the slot value of the base model ib on the computing node j; x_{ib,j} represents the base model ib deployed on the computing node j; ib∈ [symbol] _{base} represents a set of all the base models; and j∈ [symbol] _{pod} represents a set of all the computing nodes.

It should be noted that equation (7) represents that the deployment of the LoRA models on each computing node depends on the corresponding base model, and the sum of the ranks of the LoRA models (the ranks of the low-rank matrices in the LoRA models) deployed on the computing node is no more than the slot (resource unit) of the base model on the computing node, so as to constrain the model deployment rule of the models on the computing nodes.

$${x}_{i , j} = 0 , ∀ i ∈ {𝕊}_{model} , j ∉ {𝕊}_{pod \_ allow}^{i} Where j ∉ {𝕊}_{pod \_ allow}^{i} \qquad ( 8 )$$

represents a set of computing nodes on which the model i is not allowed to be deployed; i∈ [symbol] _{model} represents a set of all the base models and the LoRA models; and x_{i,j}=0 represents that the model i is not allowed to be deployed on the computing node j.

It should be noted that equation (8) represents that each model is only allowed to be deployed on the computing nodes on which the deployment is allowed, so as to constrain the model deployment rule of the models on the computing nodes.

$${\sum }_{j ∈ 𝕊} {x}_{i , j} \geq {min\_replica}_{i} ∀ i ∈ {𝕊}_{model} \qquad ( 9 )$$

Where min_replicaᵢ represents the minimum number of copies of the model i.

It should be noted that equation (9) actually represents that the number of computing nodes on which each model is deployed is no less than the minimum number of copies of the model, so as to constrain the model deployment rule of the models on the computing nodes.

$${x}_{i , j} = {\hat{x}}_{i , j} , ∀ i ∈ {𝕊}_{model} , j ∈ {𝕊}_{pod \_ freeze}^{i} Where j ∈ {𝕊}_{pod \_ freeze}^{i} \qquad ( 10 )$$

represents a set of computing nodes that need to maintain the original model orchestration mode of the model i; \hat{x}_{i,j} represents the original model orchestration mode of the model i; and x_{i,j} represents the target model orchestration mode of the model i after scheduling.

It should be noted that equation (10) actually represents that when the model rescheduling request indicates that the model i on the computing node j needs to maintain the original model orchestration mode, then the deployment of the model i on the computing node j remains unchanged before and after scheduling, so as to constrain the model deployment rule of the models on the computing nodes.

$${\sum }_{i ∈ {𝕊}_{model}} {y}_{i , j} \leq {quota}_{j} , ∀ j ∈ {𝕊}_{pod}^{i} Where j ∈ {𝕊}_{pod}^{i} \qquad ( 11 )$$

represents the model i deployed on the set of all the computing nodes; quotaⱼ represents the maximum traffic that can be carried on the computing node j; and y_{i,j} represents the inference traffic carried on the model i on the computing node j.

It should be noted that equation (11) represents that the total inference traffic received by the model deployed on each computing node is no more than the maximum traffic that the computing node can carry, so as to constrain the traffic allocation rule for allocating the inference traffic to the computing nodes.

$${\sum }_{j ∈ {𝕊}_{pod \_ guarantee}^{i , k}} {y}_{i , j} \geq {guarantee}_{i , k} , ∀ i ∈ {𝕊}_{model} , k ∈ {𝕊}_{guarantee}^{i} Where j ∈ {𝕊}_{pod \_ guarantee}^{i , k} \qquad ( 12 )$$

represents a set of the k-th group of computing nodes with the minimum guaranteed traffic requirement for the model i; guarantee_{i,k} represents the minimum guaranteed traffic that needs to be allocated for the model i on the k-th group of computing nodes; and

$$k ∈ {𝕊}_{guarantee}^{i}$$

represents a set of the minimum guaranteed traffic requirements for the model i.

It should be noted that equation (12) actually represents that the minimum guaranteed traffic requirement of each model on a set of computing nodes is satisfied so as to constrain the traffic allocation rule for allocating the inference traffic to the computing nodes.

It should be noted that the first constraint constrains the traffic allocation rule for allocating the inference traffic to the computing nodes through equations (4), (5), (11) and (12), and constrains the model deployment rule of the models on the computing nodes through equations (6), (7), (8), (9) and (10). Thus, the model deployment rule of the models on the computing nodes and the traffic allocation rule for allocating the inference traffic to the computing nodes are constrained by the first constraint so as to influence the target model orchestration mode and the target inference traffic allocation mode that are obtained by calculation.

In the embodiments of the present disclosure, the node information, the model information and the inference traffic information may be input into the optimization model. Through the scheduling algorithm, the value of x_{i,j} is calculated to determine the target model orchestration mode and the value of y_{i,j} is calculated to determine the target inference traffic allocation mode within the first constraint corresponding to the optimization model.

Therefore, by inputting the node information, the model information and the inference traffic information into the optimization model and determining the target scheduling strategy satisfying the collaborative scheduling objective within the first constraint corresponding to the optimization model, it is possible to make the target scheduling strategy obtained by calculation satisfy the collaborative scheduling objective while satisfying the model deployment rule and the traffic allocation rule.

In some achievable implementations, in S230, the node information, the model information and the inference traffic information mat be input into the optimization model, and the target scheduling strategy that satisfies the collaborative scheduling objective is determined through a plurality of iteration processes within a first constraint and a second constraint corresponding to the optimization model.

Here, the first constraint is used to constrain the model deployment rule for the models on the computing nodes and the traffic allocation rule for allocating the inference traffic to the computing nodes. It should be understood that the first constraint can be known with reference to the relevant description of the above implementation and thus will not be repeated here.

The second constraint is used to ensure that, between the target model orchestration modes determined in multiple iteration process, the reduction in the number of the computing nodes on which each model is deployed does not exceed a preset number.

The number of the computing nodes reduced for model deployment between the target model orchestration mode determined in the current iteration process and the target model orchestration mode determined in the previous iteration process need to be less than the preset number. For example, this preset number may be 1. That is, before and after each model rescheduling, the number of the computing nodes on which each model is deployed should be reduced by at most one, thereby optimizing the target model orchestration mode through the plurality of iterations.

It is should be noted that, through the second constraint, the target model orchestration mode obtained from a single calculation may be adjusted within a small range. Thus, by adjusting the target model orchestration mode within a small range in each iteration process, and through adjustment in the plurality of iteration processes, the final target model orchestration mode can be gradually optimized. Thereby, the final target model orchestration mode is obtained.

For example, the second constraint may be as follows:

$${\sum }_{j ∈ {𝕊}_{pod}} {x}_{i , j} \geq {\sum }_{j ∈ {𝕊}_{pod}} {\hat{x}}_{i , j} - 1 , ∀ i ∈ {𝕊}_{model}^{i}$$

Where \hat{x}_{i,j} represents the original model orchestration mode of the model i; and x_{i,j} represents the target model orchestration mode of the model i after scheduling.

Therefore, through the second constraint, the target model orchestration mode determined in each round of iteration can be adjusted within a small range relative to the target model orchestration mode determined in the previous round of iteration under the model scheduling of the plurality of iterations, thereby keeping the stability of the model platform.

In some achievable implementations, in S230, the node information, the model information and the inference traffic information may be input into the optimization model, and the target scheduling strategy that satisfies the collaborative scheduling objective is determined within a first constraint and a third constraint corresponding to the optimization model.

Here, the first constraint is used to constrain the model deployment rule for the models on the computing nodes and the traffic allocation rule for allocating the inference traffic to the computing nodes. It should be understood that the first constraint can be known with reference to the relevant description of the above implementation and thus will not be repeated here.

The third constraint is used to ensure that the target model orchestration mode that is determined allows direct deployment of a new model while maintaining an original model orchestration mode on the target computing nodes.

For example, the third constraint is used to enable the computing node on which a new model is deployed to have the new model directly deployed thereon in the target model orchestration mode while maintaining the original model orchestration mode on the computing node.

The computing node on which a new model is deployed refers to a computing node on which a new model needs to be deployed in the target model orchestration mode. As shown in FIG. 1, when it is necessary to add and deploy the LoRA model A5 on the computing node 1 in the target model orchestration mode, then the computing node 1 is the computing node on which a new model is deployed.

For example, the third constraint may be expressed as:

$${\sum }_{ib ∈ {𝕊}_{base}} {inc}_{ib , j} = 0 , ∀ ( ib , j ) ∈ \{ {𝕊}_{base} \times {𝕊}_{pod} \vert {\hat{x}}_{ib , j} = 1 \}$$

$${\sum }_{il ∈ {𝕊}_{LoRA}^{ib}} {rank}_{il} \cdot ( {x}_{il , j} + {inc}_{il , j} ) \leq {slot}_{ib , j} , ∀ ( ib , j ) ∈ \{ {𝕊}_{base} \times {𝕊}_{pod} \vert {\hat{x}}_{ib , j} = 1 \}$$

Where \hat{x}_{il,j} represents the original model orchestration mode of the LoRA model il on the computing node j; \hat{x}_{ib,j} represents the original model orchestration mode of the base model ib on the computing node j; inc_{ib,j} represents whether a model creation action for the base model ib occurs on the computing node j during conversion from the original model orchestration mode to the target model orchestration mode; and inc_{il,j} represents whether a model creation action for the LoRA model il occurs on the computing node j during conversion from the original model orchestration mode to the target model orchestration mode.

In other words, through the third constraint, the computing node on which a new model is deployed can be made to have the new model deployed thereon in the target model orchestration mode while maintaining the original model orchestration mode on the computing node.

For example, as shown in FIG. 1, when it is necessary to add and deploy the LoRA model A5 on the computing node 1 in the target model orchestration mode, then the computing node 1 is the computing node on which a new model is deployed. Under the third constraint, it is necessary for the computing node 1 to still have sufficient space to deploy the LoRA model A5 in the target model orchestration mode while maintaining the deployment of the LoRA model A1, the LoRA model A3, the LoRA model A9 and the base model A.

Accordingly, in some embodiments, in S240, in response to the target model orchestration mode representing the deployment of a new model on any of the target computing nodes, firstly deploy models specified by the target model orchestration mode on the any of the target computing node; and after the deployment of the new model is completed, delete the models which are deployed on the target computing node before the deployment of the new model.

In other words, in the embodiments of the present disclosure, model scheduling is achieved by firstly adding and deploying a new model and then deleting the originally deployed models. For example, in the target model orchestration mode, when the LoRA model A3 and the base model A are scheduled and deployed on the computing node 1, then the LoRA model A3 and the base model A are added and deployed on the computing node I while maintaining the deployment of the LoRA model A1, the LoRA model A3, the LoRA model A9 and the base model A on the computing node 1. Then, after the LoRA model A3 and the base model A are successfully deployed, the LoRA model A1, the LoRA model A3, the LoRA model A9 and the base model A that are originally deployed on the computing node 1 are deleted, thus completing the model scheduling of the computing node 1.

Therefore, through the above implementation, it is possible to avoid the interruption of the model platform during the model rescheduling process, ensure that the inference traffic can be effectively processed even in the rescheduling process, and greatly guarantee the user experience.

It should be noted that in the embodiments of the present disclosure, the second constraint and the third constraint may also be used simultaneously. In other words, the model information, the node information and the inference traffic information may be input into the optimization model to determine, within the given first constraint, second constraint and third constraint, the target model orchestration mode and the target inference traffic allocation mode that satisfy the collaborative scheduling objective.

In some achievable implementations, in S230, the node information, the model information and the inference traffic information may be input into the optimization model to determine the target scheduling strategy that enables the optimization model to achieve the collaborative scheduling objective.

Here, the collaborative scheduling objective comprises a model orchestration objective corresponding to the model orchestration dimension and a traffic load balancing objective corresponding to the load balancing dimension, the model orchestration objective is used to indicate minimizing the number of the target computing nodes used for deploying the models, and the traffic load balancing objective is used to indicate minimizing a peak value of the inference traffic allocated by the model platform to the target computing nodes.

The collaborative scheduling objective includes a model orchestration objective for rescheduling in the model orchestration dimension and a traffic load balancing objective for rescheduling in the load balancing dimension. In other words, the collaborative scheduling objective involves collaborative scheduling with a plurality of objectives (the model orchestration objective and the traffic load balancing objective).

The number of the target computing nodes used for deploying the models refers to the number of the target computing nodes needed for deploying the plurality of models. By minimizing the number of the target computing nodes used for deploying the models, the deployment density of the models on the target computing nodes can be improved. The peak value of the inference traffic allocated by the model platform to the target computing nodes refers to the maximum inference traffic allocated by the model platform to each target computing nodes. By minimizing the peak value of the inference traffic allocated by the model platform to the target computing nodes, the load balancing for allocation of the inference traffic to the plurality of target computing nodes can be achieved.

In some embodiments, it is also possible to configure a first weight for the model orchestration objective and a second weight for the traffic load balancing objective.

The first weight is used to indicate a scheduling priority of the model orchestration objective and the second weight is used to indicate a scheduling priority of the traffic load balancing objective, so as to adjust the priority between the target model orchestration mode and the target inference traffic allocation mode.

It should be noted that by configuring different first weight and the second weight, the tendency of the optimization direction of model rescheduling may be selected between the model orchestration mode and the traffic allocation mode. For example, when the second weight is greater than the first weight, it represents that the collaborative scheduling objective tends to be optimized towards the traffic load balancing objective. When the second weight is smaller than the first weight, it represents that the collaborative scheduling objective tends to be optimized towards the model orchestration objective. When the second weight is equal to the first weight, it represents that the collaborative scheduling objective is optimized towards both the traffic load balancing objective and the model orchestration objective.

It should be understood that the first weight and the second weight may be determined by the cluster size of the model platform.

For example, the collaborative scheduling objective may be expressed by the following objective function:

$$min {w}_{1} \cdot {\sum }_{j ∈ {𝕊}_{pod}} {z}_{j} + {w}_{2} \cdot {max}_{j ∈ {𝕊}_{pod}} ( {\sum }_{j ∈ {𝕊}_{model}} {y}_{i , j} )$$

Where w₁ is the first weight; w₂ is the second weight; [symbol] _{pod}zⱼ represents the number of the target computing nodes used for deploying the models; and

$${max}_{j ∈ {𝕊}_{pod}} ( {\sum }_{j ∈ {𝕊}_{model}} {y}_{i , j} )$$

represents the peak value of the inference traffic allocated by the model platform to the target computing nodes.

It should be noted that by minimizing the number of the target computing nodes used for deploying the models and minimizing the peak value of the inference traffic allocated by the model platform to the target computing nodes, the collaborative scheduling objective can enable the target model orchestration mode that is determined and target inference traffic allocation mode to be optimized collaboratively in the model orchestration dimension and the load balancing dimension.

Therefore, through the above collaborative scheduling objective, the model orchestration mode and the traffic allocation mode in the model platform can be optimized dynamically, thereby reducing the idle time caused by loading low-traffic model copies and improving the resource utilization of the model platform. Moreover, the models can be reasonably scheduled and allocated according to the load of the inference traffic so as to reduce fragmented resources on the computing nodes, and more computing nodes can be spared by means of the tidal effect of the inference traffic, thereby increasing the deployment density of the models on the model platform. Additionally, by minimizing the number of the target computing nodes used for deploying the models and minimizing the peak value of the inference traffic allocated by the model platform to the target computing nodes, the load on the model platform can be made more balanced so as to avoid certain computing nodes from bearing excessive inference traffic and reduce inference latency.

In some achievable implementations, in S230, the node information, the model information and the inference traffic information may be input into the optimization model to determine the target scheduling strategy that enables the optimization model to achieve the collaborative scheduling objective.

Here, the collaborative scheduling objective includes a model orchestration objective corresponding to the model orchestration dimension, a traffic load balancing objective corresponding to the load balancing dimension and a model migration cost objective. The model orchestration objective is used to indicate minimizing the number of the target computing nodes used for deploying the models, the traffic load balancing objective is used to indicate minimizing a peak value of the inference traffic allocated by the model platform to the target computing nodes, and the model migration cost objective is used to indicate minimizing the number of model migrations generated during the model rescheduling process.

Reference may be made to the relevant descriptions of the above implementations for detailed descriptions of the traffic load balancing objective and the model orchestration objective.

The number of model migrations may refer to the total number of model migration actions transmitted. The model migration actions include a model creation action and a model deletion action. The model creation action refers to creating a model on a computing node, and the model deletion action refers to deleting a model from a computing node. The number of model migrations occurring on the computing nodes refers to the total number of times the model creation action and/or the model deletion action occur on the plurality of computing nodes.

It should be understood that by minimizing the number of model migrations generated during the rescheduling process, invalid or inefficient model migration actions may be avoided in the model scheduling.

For example, the collaborative scheduling objective may be expressed by the following objective function:

$$min {w}_{1} \cdot {\sum }_{j ∈ {𝕊}_{pod}} {z}_{j} + {w}_{2} \cdot {max}_{j ∈ {𝕊}_{pod}} ( {\sum }_{j ∈ {𝕊}_{model}} {y}_{i , j} ) + σ \cdot {\sum }_{( i , j ) ∈ {𝕊}_{model} \times {𝕊}_{pod}} ( {inc}_{i , j} + {dec}_{i , j} )$$

Where σ is a penalty coefficient close to zero; and [symbol] (inc_{i,j}+dec_{i,j}) represents the number of model migrations generated during the model rescheduling process.

It should be noted that when the model orchestration objective and the traffic load balancing objective have been optimized to the optimal direction, then in this case, it is possible to continue optimizing the number of model migrations generated during the model rescheduling process under the model migration cost objective. In other words, after the number of the target computing nodes used for deploying the models and the peak value of the inference traffic allocated by the model platform to the target computing nodes have been optimized to the best, the number of model migrations generated during the model rescheduling process may be further optimized. Thereby, both the target model orchestration mode and the target inference traffic allocation mode can be optimized to the best under the model orchestration objective corresponding to the model orchestration dimension, the traffic load balancing objective corresponding to the load balancing dimension, and the model migration cost objective.

Therefore, through the above collaborative scheduling objective, not only the model orchestration mode and the traffic allocation mode can be optimized collaboratively, but also invalid or inefficient model migration actions can be avoided. Thus, the optimal model deployment and traffic scheduling can be achieved with the minimum number of model migration actions.

FIG. 3 is a structural schematic diagram of a model platform-based scheduling apparatus according to at least one embodiment of the present disclosure. As shown in FIG. 3, the embodiments of the present disclosure provide a model platform-based scheduling apparatus 300, which includes:
a receiving module 301, which is configured to receive a model rescheduling request for a model platform, where the model platform provides an inference service through models deployed on a computing cluster, and the model rescheduling request is used to request collaborative scheduling of the models on the computing cluster in a model orchestration dimension and a load balancing dimension;
a first determination module 302, which is configured to determine, from the computing cluster, a plurality of target computing nodes participating in rescheduling according to the model rescheduling request;
a second determination module 303, which is configured to determine a target scheduling strategy that satisfies a collaborative scheduling objective of the collaborative scheduling in the model orchestration dimension and the load balancing dimension, combined with an optimization model, according to node information of the plurality of target computing nodes, model information corresponding to models carried by the plurality of target computing nodes and inference traffic information carried by the plurality of target computing nodes, where the target scheduling strategy comprises a target model orchestration mode and a target inference traffic allocation mode;
a scheduling module 304, which is configured to reschedule the models carried by the target computing nodes according to the target model orchestration mode, and control allocation of inference traffic to the target computing nodes according to the target inference traffic allocation mode.

Optionally, the second determination module 303 is further configured to:
input the node information, the model information and the inference traffic information into the optimization model to determine the target scheduling strategy that enables the optimization model to achieve the collaborative scheduling objective;
where the collaborative scheduling objective includes a model orchestration objective corresponding to the model orchestration dimension and a traffic load balancing objective corresponding to the load balancing dimension, the model orchestration objective is used to indicate minimizing a number of the target computing nodes used for deploying the models, and the traffic load balancing objective is used to indicate minimizing a peak value of the inference traffic allocated by the model platform to the target computing nodes.

Optionally, the second determination module 303 is further configured to:
input the node information, the model information and the inference traffic information into the optimization model to determine the target scheduling strategy that enables the optimization model to achieve the collaborative scheduling objective;
where the collaborative scheduling objective includes a model orchestration objective corresponding to the model orchestration dimension, a traffic load balancing objective corresponding to the load balancing dimension and a model migration cost objective, the model orchestration objective is used to indicate minimizing a number of the target computing nodes used for deploying the models, the traffic load balancing objective is used to indicate minimizing a peak value of the inference traffic allocated by the model platform to the target computing nodes, and the model migration cost objective is used to indicate minimizing a number of model migrations generated during a model rescheduling process.

Optionally, the second determination module 303 is further configured to:
configure a first weight for the model orchestration objective and a second weight for the traffic load balancing objective, where the first weight is used to indicate a scheduling priority of the model orchestration objective, and the second weight is used to indicate a scheduling priority of the traffic load balancing objective.

Optionally, the second determination module 303 is further configured to:
input the node information, the model information and the inference traffic information into the optimization model, and determining the target scheduling strategy that satisfies the collaborative scheduling objective within a first constraint corresponding to the optimization model;
where the first constraint is used to constrain a model deployment rule for the models on the computing nodes and a traffic allocation rule for allocating the inference traffic to the computing nodes. Optionally, the second determination module 303 is further configured to:

input the node information, the model information and the inference traffic information into the optimization model, and determining the target scheduling strategy that satisfies the collaborative scheduling objective through a plurality of iteration processes within a first constraint and a second constraint corresponding to the optimization model;
where the first constraint is used to constrain a model deployment rule for the models on the computing nodes and a traffic allocation rule for allocating the inference traffic to the computing nodes, and the second constraint is used to ensure that, between the target model orchestration modes determined in multiple iteration process, the reduction in the number of the computing nodes on which each model is deployed does not exceed a preset number.

Optionally, the second determination module 303 is further configured to:
input the node information, the model information and the inference traffic information into the optimization model, and determining the target scheduling strategy that satisfies the collaborative scheduling objective within a first constraint and a third constraint corresponding to the optimization model;
where the first constraint is used to constrain a model deployment rule for the models on the computing nodes and a traffic allocation rule for allocating the inference traffic to the computing nodes, and the third constraint is used to ensure the target model orchestration mode that is determined allows direct deployment of a new model while maintaining an original model orchestration mode on the target computing nodes.

Optionally, the scheduling module 304 is further configured to:
in response to the target model orchestration mode representing the deployment of the new model on any of the target computing nodes, firstly deploy models specified by the target model orchestration mode on the any of the target computing nodes; and after the deployment of the new model is completed, delete the models which are deployed on the any of the target computing nodes before the deployment of the new model.

Regarding the functional logic executed by each functional module in the aforementioned model platform-based scheduling apparatus 300, detailed descriptions have already been provided in the method section and thus will not be reiterated here.

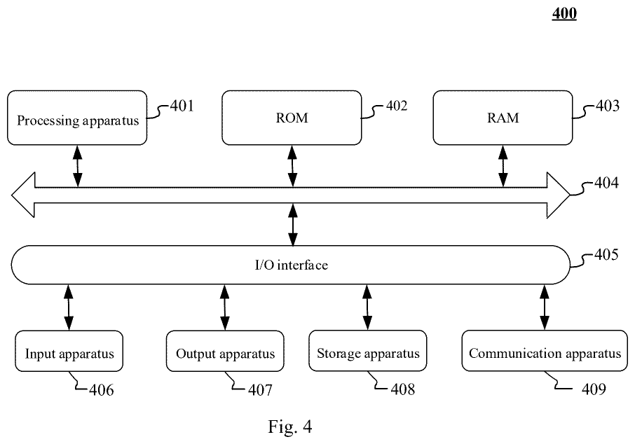

FIG. 4 is specifically referred below, and it shows the structure schematic diagram suitable for achieving the electronic device 400 in the embodiment of the present disclosure. The electronic device 400 in the embodiment of the present disclosure may include but not be limited to a mobile terminal such as a mobile phone, a notebook computer, a digital broadcasting receiver, a personal digital assistant (PDA), a PAD (tablet computer), a portable multimedia player (PMP), a vehicle terminal (such as a vehicle navigation terminal), and a fixed terminal such as a digital television (TV) and a desktop computer. The electronic device shown in FIG. 4 is only an example and should not impose any limitations on the functions and use scopes of the embodiments of the present disclosure.

As shown in FIG. 4, the electronic device 400 may include a processing apparatus (such as a central processing unit, and a graphics processor) 401, it may execute various appropriate actions and processes according to a program stored in a read-only memory (ROM) 402 or a program loaded from a storage apparatus 408 to a random access memory (RAM) 403. In RAM 403, various programs and data required for operations of the electronic device 400 are also stored. The processing apparatus 401, ROM 402, and RAM 403 are connected to each other by a bus 404. An input/output (I/O) interface 405 is also connected to the bus 404.

Typically, the following apparatuses may be connected to the I/O interface 405: an input apparatus 406 such as a touch screen, a touchpad, a keyboard, a mouse, a camera, a microphone, an accelerometer, and a gyroscope; an output apparatus 407 such as a liquid crystal display (LCD), a loudspeaker, and a vibrator; a storage apparatus 408 such as a magnetic tape, and a hard disk drive; and a communication apparatus 409. The communication apparatus 409 may allow the electronic device 400 to wireless-communicate or wire-communicate with other devices so as to exchange data. Although FIG. 4 shows the electronic device 400 with various apparatuses, it should be understood that it is not required to implement or possess all the apparatuses shown. Alternatively, it may implement or possess the more or less apparatuses.

Specifically, according to the embodiment of the present disclosure, the process described above with reference to the flow diagram may be achieved as a computer software program. For example, an embodiment of the present disclosure includes a computer program product, it includes a computer program loaded on a non-transient computer-readable medium, and the computer program contains a program code for executing the method shown in the flow diagram. In such an embodiment, the computer program may be downloaded and installed from the network by the communication apparatus 409, or installed from the storage apparatus 408, or installed from ROM 402. When the computer program is executed by the processing apparatus 401, the above functions defined in the method in the embodiments of the present disclosure are executed.

It should be noted that the above computer-readable medium in the present disclosure may be a computer-readable signal medium, a computer-readable storage medium, or any combinations of the two. The computer-readable storage medium may be, for example, but not limited to, a system, an apparatus or a device of electricity, magnetism, light, electromagnetism, infrared, or semiconductor, or any combinations of the above. More specific examples of the computer-readable storage medium may include but not be limited to: an electric connector with one or more wires, a portable computer magnetic disk, a hard disk drive, a random access memory (RAM), a read-only memory (ROM), an erasable programmable read-only memory (EPROM or flash memory), an optical fiber, a portable compact disk read-only memory (CD-ROM), an optical storage device, a magnetic storage device or any suitable combinations of the above. In the present disclosure, the computer-readable storage medium may be any visible medium that contains or stores a program, and the program may be used by an instruction executive system, apparatus or device or used in combination with it. In the present disclosure, the computer-readable signal medium may include a data signal propagated in a baseband or as a part of a carrier wave, it carries the computer-readable program code. The data signal propagated in this way may adopt various forms, including but not limited to an electromagnetic signal, an optical signal, or any suitable combinations of the above. The computer-readable signal medium may also be any computer-readable medium other than the computer-readable storage medium, and the computer-readable signal medium may send, propagate, or transmit the program used by the instruction executive system, apparatus or device or in combination with it. The program code contained on the computer-readable medium may be transmitted by using any suitable medium, including but not limited to: a wire, an optical cable, a radio frequency (RF) or the like, or any suitable combinations of the above.

In some implementation modes, a computing node and a proxy node may be communicated by using any currently known or future-developed network protocols such as a HyperText Transfer Protocol (HTTP), and may interconnect with any form or medium of digital data communication (such as a communication network). Examples of the communication network include a local area network (“LAN”), a wide area network (“WAN”), an internet work (such as the Internet), and an end-to-end network (such as an ad hoc end-to-end network), as well as any currently known or future-developed networks.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to: receive a model rescheduling request for a model platform, where the model platform provides an inference service through models deployed on a computing cluster, and the model rescheduling request is used to request collaborative scheduling of the models on the computing cluster in a model orchestration dimension and a load balancing dimension; determine, from the computing cluster, a plurality of target computing nodes participating in rescheduling according to the model rescheduling request; determine a target scheduling strategy that satisfies a collaborative scheduling objective of the collaborative scheduling in the model orchestration dimension and the load balancing dimension, combined with an optimization model, according to node information of the plurality of target computing nodes, model information corresponding to models carried by the plurality of target computing nodes and inference traffic information carried by the plurality of target computing nodes, where the target scheduling strategy comprises a target model orchestration mode and a target inference traffic allocation mode; and reschedule the models carried by the target computing nodes according to the target model orchestration mode, and control allocation of inference traffic to the target computing nodes according to the target inference traffic allocation mode.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims. Specific manners of operations performed by the modules in the apparatus in the above embodiment have been described in detail in the embodiments regarding the method, which will not be explained and described in detail herein again.

1. A model platform-based scheduling method, comprising:
receiving a model rescheduling request for a model platform, wherein the model platform provides an inference service through models deployed on a computing cluster, and the model rescheduling request is used to request collaborative scheduling of the models on the computing cluster in a model orchestration dimension and a load balancing dimension;
determining, from the computing cluster, a plurality of target computing nodes participating in rescheduling according to the model rescheduling request;
determining a target scheduling strategy that satisfies a collaborative scheduling objective of the collaborative scheduling in the model orchestration dimension and the load balancing dimension combined with an optimization model, according to node information of the plurality of target computing nodes, model information corresponding to models carried by the plurality of target computing nodes, and inference traffic information carried by the plurality of target computing nodes, wherein the target scheduling strategy comprises a target model orchestration mode and a target inference traffic allocation mode; and
rescheduling the models carried by the target computing nodes according to the target model orchestration mode, and controlling allocation of inference traffic to the target computing nodes according to the target inference traffic allocation mode.

2. The method according to claim 1, wherein the determining a target scheduling strategy that satisfies a collaborative scheduling objective of the collaborative scheduling in the model orchestration dimension and the load balancing dimension combined with an optimization model, according to node information of the plurality of target computing nodes, model information corresponding to models carried by the plurality of target computing nodes, and inference traffic information carried by the plurality of target computing nodes, comprises:
inputting the node information, the model information and the inference traffic information into the optimization model to determine the target scheduling strategy that enables the optimization model to achieve the collaborative scheduling objective,
wherein the collaborative scheduling objective comprises a model orchestration objective corresponding to the model orchestration dimension and a traffic load balancing objective corresponding to the load balancing dimension, the model orchestration objective is used to indicate minimizing a number of the target computing nodes used for deploying the models, and the traffic load balancing objective is used to indicate minimizing a peak value of the inference traffic allocated by the model platform to the target computing nodes.

3. The method according to claim 2, further comprising:
configuring a first weight for the model orchestration objective and a second weight for the traffic load balancing objective, wherein the first weight is used to indicate a scheduling priority of the model orchestration objective, and the second weight is used to indicate a scheduling priority of the traffic load balancing objective.

4. The method according to claim 1, wherein the determining a target scheduling strategy that satisfies a collaborative scheduling objective of the collaborative scheduling in the model orchestration dimension and the load balancing dimension combined with an optimization model, according to node information of the plurality of target computing nodes, model information corresponding to models carried by the plurality of target computing nodes, and inference traffic information carried by the plurality of target computing nodes, comprises:
inputting the node information, the model information and the inference traffic information into the optimization model to determine the target scheduling strategy that enables the optimization model to achieve the collaborative scheduling objective,
wherein the collaborative scheduling objective comprises a model orchestration objective corresponding to the model orchestration dimension, a traffic load balancing objective corresponding to the load balancing dimension, and a model migration cost objective, the model orchestration objective is used to indicate minimizing a number of the target computing nodes used for deploying the models, the traffic load balancing objective is used to indicate minimizing a peak value of the inference traffic allocated by the model platform to the target computing nodes, and the model migration cost objective is used to indicate minimizing a number of model migrations generated during a model rescheduling process.

5. The method according to claim 4, further comprising:
configuring a first weight for the model orchestration objective and a second weight for the traffic load balancing objective, wherein the first weight is used to indicate a scheduling priority of the model orchestration objective, and the second weight is used to indicate a scheduling priority of the traffic load balancing objective.

6. The method according to claim 1, wherein the determining a target scheduling strategy that satisfies a collaborative scheduling objective of the collaborative scheduling in the model orchestration dimension and the load balancing dimension combined with an optimization model, according to node information of the plurality of target computing nodes, model information corresponding to models carried by the plurality of target computing nodes, and inference traffic information carried by the plurality of target computing nodes, comprises:
inputting the node information, the model information and the inference traffic information into the optimization model, and determining the target scheduling strategy that satisfies the collaborative scheduling objective within a first constraint corresponding to the optimization model,
wherein the first constraint is used to constrain a model deployment rule for the models on the computing nodes and a traffic allocation rule for allocating the inference traffic to the computing nodes.

7. The method according to claim 1, wherein the determining a target scheduling strategy that satisfies a collaborative scheduling objective of the collaborative scheduling in the model orchestration dimension and the load balancing dimension combined with an optimization model, according to node information of the plurality of target computing nodes, model information corresponding to models carried by the plurality of target computing nodes, and inference traffic information carried by the plurality of target computing nodes, comprises:
inputting the node information, the model information and the inference traffic information into the optimization model, and determining the target scheduling strategy that satisfies the collaborative scheduling objective through a plurality of iteration processes within a first constraint and a second constraint corresponding to the optimization model,
wherein the first constraint is used to constrain a model deployment rule for the models on the computing nodes and a traffic allocation rule for allocating the inference traffic to the computing nodes, and the second constraint is used to ensure that, between the target model orchestration modes determined in multiple iteration process, the reduction in the number of the computing nodes on which each model is deployed does not exceed a preset number.

8. The method according to claim 1, wherein the determining a target scheduling strategy that satisfies a collaborative scheduling objective of the collaborative scheduling in the model orchestration dimension and the load balancing dimension combined with an optimization model, according to node information of the plurality of target computing nodes, model information corresponding to models carried by the plurality of target computing nodes, and inference traffic information carried by the plurality of target computing nodes, comprises:
inputting the node information, the model information and the inference traffic information into the optimization model, and determining the target scheduling strategy that satisfies the collaborative scheduling objective within a first constraint and a third constraint corresponding to the optimization model,
wherein the first constraint is used to constrain a model deployment rule for the models on the computing nodes and a traffic allocation rule for allocating the inference traffic to the computing nodes, and the third constraint is used to ensure the target model orchestration mode that is determined allows direct deployment of a new model while maintaining an original model orchestration mode on the target computing nodes.

9. The method according to claim 8, wherein the rescheduling the models carried by the target computing nodes according to the target model orchestration mode comprises:
in response to the target model orchestration mode representing the deployment of the new model on any of the target computing nodes, firstly deploying models specified by the target model orchestration mode on the any of the target computing nodes; and after the deployment of the new model is completed, deleting the models which are deployed on the any of the target computing nodes before the deployment of the new model.

10. A non-transitory computer-readable medium, having a computer program stored thereon, wherein, when the computer program is executed by a processing apparatus, the computer program implements a model platform-based scheduling method, and the method comprises:
receiving a model rescheduling request for a model platform, wherein the model platform provides an inference service through models deployed on a computing cluster, and the model rescheduling request is used to request collaborative scheduling of the models on the computing cluster in a model orchestration dimension and a load balancing dimension;
determining, from the computing cluster, a plurality of target computing nodes participating in rescheduling according to the model rescheduling request;
determining a target scheduling strategy that satisfies a collaborative scheduling objective of the collaborative scheduling in the model orchestration dimension and the load balancing dimension, combined with an optimization model, according to node information of the plurality of target computing nodes, model information corresponding to models carried by the plurality of target computing nodes and inference traffic information carried by the plurality of target computing nodes, wherein the target scheduling strategy comprises a target model orchestration mode and a target inference traffic allocation mode; and
rescheduling the models carried by the target computing nodes according to the target model orchestration mode, and controlling allocation of inference traffic to the target computing nodes according to the target inference traffic allocation mode.

11. The non-transitory computer-readable medium according to claim 10, wherein the determining a target scheduling strategy that satisfies a collaborative scheduling objective of the collaborative scheduling in the model orchestration dimension and the load balancing dimension combined with an optimization model, according to node information of the plurality of target computing nodes, model information corresponding to models carried by the plurality of target computing nodes, and inference traffic information carried by the plurality of target computing nodes, comprises:
inputting the node information, the model information and the inference traffic information into the optimization model to determine the target scheduling strategy that enables the optimization model to achieve the collaborative scheduling objective,
wherein the collaborative scheduling objective comprises a model orchestration objective corresponding to the model orchestration dimension and a traffic load balancing objective corresponding to the load balancing dimension, the model orchestration objective is used to indicate minimizing a number of the target computing nodes used for deploying the models, and the traffic load balancing objective is used to indicate minimizing a peak value of the inference traffic allocated by the model platform to the target computing nodes.

12. An electronic device, comprising:
at least one storage apparatus, having a computer program stored thereon; and
at least one processing apparatus, configured to execute the computer program in the at least one storage apparatus to implement a model platform-based scheduling method, wherein the method comprises:
receiving a model rescheduling request for a model platform, wherein the model platform provides an inference service through models deployed on a computing cluster, and the model rescheduling request is used to request collaborative scheduling of the models on the computing cluster in a model orchestration dimension and a load balancing dimension;
determining, from the computing cluster, a plurality of target computing nodes participating in rescheduling according to the model rescheduling request;
determining a target scheduling strategy that satisfies a collaborative scheduling objective of the collaborative scheduling in the model orchestration dimension and the load balancing dimension, combined with an optimization model, according to node information of the plurality of target computing nodes, model information corresponding to models carried by the plurality of target computing nodes and inference traffic information carried by the plurality of target computing nodes, wherein the target scheduling strategy comprises a target model orchestration mode and a target inference traffic allocation mode; and
rescheduling the models carried by the target computing nodes according to the target model orchestration mode, and controlling allocation of inference traffic to the target computing nodes according to the target inference traffic allocation mode.

13. The electronic device according to claim 12, wherein the determining a target scheduling strategy that satisfies a collaborative scheduling objective of the collaborative scheduling in the model orchestration dimension and the load balancing dimension combined with an optimization model, according to node information of the plurality of target computing nodes, model information corresponding to models carried by the plurality of target computing nodes, and inference traffic information carried by the plurality of target computing nodes, comprises:
inputting the node information, the model information and the inference traffic information into the optimization model to determine the target scheduling strategy that enables the optimization model to achieve the collaborative scheduling objective,
wherein the collaborative scheduling objective comprises a model orchestration objective corresponding to the model orchestration dimension and a traffic load balancing objective corresponding to the load balancing dimension, the model orchestration objective is used to indicate minimizing a number of the target computing nodes used for deploying the models, and the traffic load balancing objective is used to indicate minimizing a peak value of the inference traffic allocated by the model platform to the target computing nodes.

14. The electronic device according to claim 13, wherein the method further comprises:
configuring a first weight for the model orchestration objective and a second weight for the traffic load balancing objective, wherein the first weight is used to indicate a scheduling priority of the model orchestration objective, and the second weight is used to indicate a scheduling priority of the traffic load balancing objective.

15. The electronic device according to claim 12, wherein the determining a target scheduling strategy that satisfies a collaborative scheduling objective of the collaborative scheduling in the model orchestration dimension and the load balancing dimension combined with an optimization model, according to node information of the plurality of target computing nodes, model information corresponding to models carried by the plurality of target computing nodes, and inference traffic information carried by the plurality of target computing nodes, comprises:
inputting the node information, the model information and the inference traffic information into the optimization model to determine the target scheduling strategy that enables the optimization model to achieve the collaborative scheduling objective,
wherein the collaborative scheduling objective comprises a model orchestration objective corresponding to the model orchestration dimension, a traffic load balancing objective corresponding to the load balancing dimension, and a model migration cost objective, the model orchestration objective is used to indicate minimizing a number of the target computing nodes used for deploying the models, the traffic load balancing objective is used to indicate minimizing a peak value of the inference traffic allocated by the model platform to the target computing nodes, and the model migration cost objective is used to indicate minimizing a number of model migrations generated during a model rescheduling process.

16. The electronic device according to claim 15, wherein the method further comprises:
configuring a first weight for the model orchestration objective and a second weight for the traffic load balancing objective, wherein the first weight is used to indicate a scheduling priority of the model orchestration objective, and the second weight is used to indicate a scheduling priority of the traffic load balancing objective.

17. The electronic device according to claim 12, wherein the determining a target scheduling strategy that satisfies a collaborative scheduling objective of the collaborative scheduling in the model orchestration dimension and the load balancing dimension combined with an optimization model, according to node information of the plurality of target computing nodes, model information corresponding to models carried by the plurality of target computing nodes, and inference traffic information carried by the plurality of target computing nodes, comprises:
inputting the node information, the model information and the inference traffic information into the optimization model, and determining the target scheduling strategy that satisfies the collaborative scheduling objective within a first constraint corresponding to the optimization model,
wherein the first constraint is used to constrain a model deployment rule for the models on the computing nodes and a traffic allocation rule for allocating the inference traffic to the computing nodes.

18. The electronic device according to claim 12, wherein the determining a target scheduling strategy that satisfies a collaborative scheduling objective of the collaborative scheduling in the model orchestration dimension and the load balancing dimension combined with an optimization model, according to node information of the plurality of target computing nodes, model information corresponding to models carried by the plurality of target computing nodes, and inference traffic information carried by the plurality of target computing nodes, comprises:
inputting the node information, the model information and the inference traffic information into the optimization model, and determining the target scheduling strategy that satisfies the collaborative scheduling objective through a plurality of iteration processes within a first constraint and a second constraint corresponding to the optimization model,
wherein the first constraint is used to constrain a model deployment rule for the models on the computing nodes and a traffic allocation rule for allocating the inference traffic to the computing nodes, and the second constraint is used to ensure that, between the target model orchestration modes determined in multiple iteration process, the reduction in the number of the computing nodes on which each model is deployed does not exceed a preset number.

19. The electronic device according to claim 12, wherein the determining a target scheduling strategy that satisfies a collaborative scheduling objective of the collaborative scheduling in the model orchestration dimension and the load balancing dimension, combined with an optimization model, according to node information of the plurality of target computing nodes, model information corresponding to models carried by the plurality of target computing nodes and inference traffic information carried by the plurality of target computing nodes, comprises:
inputting the node information, the model information and the inference traffic information into the optimization model, and determining the target scheduling strategy that satisfies the collaborative scheduling objective within a first constraint and a third constraint corresponding to the optimization model;
wherein the first constraint is used to constrain a model deployment rule for the models on the computing nodes and a traffic allocation rule for allocating the inference traffic to the computing nodes, and the third constraint is used to ensure the target model orchestration mode that is determined allows direct deployment of a new model while maintaining an original model orchestration mode on the target computing nodes.

20. The electronic device according to claim 19, wherein the rescheduling the models carried by the target computing nodes according to the target model orchestration mode comprises:
in response to the target model orchestration mode representing the deployment of the new model on any of the target computing nodes, firstly deploying models specified by the target model orchestration mode on the any of the target computing nodes; and after the deployment of the new model is completed, deleting the models which are deployed on the any of the target computing nodes before the deployment of the new model.
